(19) United States
(12) Patent Application Publication
(10) Pub. No.: US 2005/0253417 A1
(43) Pub. Date: Nov. 17, 2005

(54) Recreational trailer

(76) Inventor: Michael Cundy, Horicon, WI (US)

Correspondence Address: Richard C. Litman;LITMAN LAW OFFICES, LTD., P.O. Box 15035, Arlington, VA, 22215, US

(21) Appl. No.: 10/844,429

(22) Filed: May 13, 2004

(51) Int. Cl. B60T 3/00

(52) U.S. Cl. 296/168; 410/30

(57) ABSTRACT

A portable, lightweight trailer that is designed for activities such as ice fishing and camping. The trailer has framework fabricated of aluminum tubing. The wall panels (interior, exterior) and the roof are respectively made from aluminum sheeting and galvanized steel. Insulation and electrical wiring are disposed between the interior and exterior wall panels. The trailer can be mounted on wheels for towing along the highway or it may be mounted on skis when utilized for ice fishing. The use of aluminum materials insures that the trailer is light enough to be towed by an ATV.

### BACKGROUND OF THE INVENTION

1. Field of the Invention

The present invention generally relates to recreational equipment. More specifically, the present invention is drawn to a lightweight, towable trailer designed for activities such as camping, hunting, ice fishing, etc. The invention also functions as an enclosed utility trailer for motorcycles and ATVs.

2. Description of the Related Art

Every season (spring, summer, winter, fall) enthusiasts hit the road to partake in the adventures that abound in the great outdoors. At times, parks and wilderness areas are choked with recreational vehicles (RVs) and the like. The modern RV includes amenities that are almost home-like. Refrigerators, TVs, stereo systems, gas heaters, air conditioners, etc. are considered standard items in the modern RV. Often, the camper would like to have access to a small, motorized vehicle to explore the wilderness. Vehicles such as mountain bikes, motorcycles and All Terrain Vehicles (ATV) have become popular in this endeavor. Currently transporting such vehicles is a cumbersome chore in that the vehicles must be mounted and dismounted to the exterior of the camper. A lightweight, towable trailer spacious enough to house comfort amenities and to also house small vehicles such as motorcycles, which trailer can also function as an ice shanty in winter, would certainly be a welcome addition to the art.

There are many convertible trailers known in the related art, examples of which are shown in U.S. Patents numbered U.S. Pat. No. 4,511,174 (Walker), U.S. Pat. No. 5,462,330 (Brown), U.S. Pat. No. 6,017,081 (Colby), U.S. Pat. No. 6,283,537 B1 (Devore, III) and Patent Application Publication 2003/0140573 A1 (Marcinkowski et al.). The cited references are collapsible and could not house small motor vehicles. Note that there are no amenities associated with the campers.

U.S. Patents numbered U.S. Pat. No. 2,891,562 (Kruczynski) and U.S. Pat. No. 3,854,746 (Flynn et al.) disclose ice shanties mounted on sleds. The shanties are collapsible and too small to house an ATV or motorcycle.

U.S. Patent numbered U.S. Pat. No. 6,682,082 B1 (Dalen) is drawn to an ice shanty adapted for mounting on skis. The patentee does not contemplate providing amenities or housing vehicles in the shanty.

U.S. Patent numbered U.S. Pat. No. 6,439,645 B1 (Pedersen) shows an enclosure for an ATV. The enclosure is not provided with wheels or skis.

None of the above inventions and patents, taken either singly or in combination, is seen to disclose a recreational trailer as will be subsequently described and claimed in the instant invention.

### SUMMARY OF THE INVENTION

The present invention is a portable, lightweight trailer that is designed for activities such as ice fishing and camping. The trailer has framework fabricated of aluminum tubing. The wall panels (interior, exterior) and the roof are respectively made from aluminum sheeting and galvanized steel. Insulation and electrical wiring are disposed between the interior and exterior wall panels. The trailer can be mounted on wheels for towing along the highway or it may be mounted on skis when utilized for ice fishing. The use of aluminum materials insures that the trailer is light enough to be towed by an ATV. This is especially advantageous when the trailer is used for ice fishing in that the risk of driving a more expensive, heavier vehicle to tow the trailer on the ice is eliminated. The trailer is equipped with many amenities such as a TV, stereo, interior lights, heater, etc. Windows are provided as well as front and rear vents. Structure is also provided for mounting motorcycles interiorly. As presently contemplated the trailer may be made in six, eight, ten, twelve and fourteen feet sizes.

Accordingly, the present invention presents a portable, lightweight trailer that can be utilized for camping and/or ice fishing. The trailer is large enough to house a standard ATV. An array of amenities such as TV, stereo, lights, heater, etc. is disposed in the interior of the trailer. Accessories for mounting motorcycles are also disposed in the interior of the trailer.

The invention provides for improved elements and arrangements thereof for the purposes described which are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective, rear view of a recreational trailer according to the present invention.

FIG. 2 is an environmental, perspective, front view of a recreational trailer according to the present invention.

FIG. 3 is a perspective view of the interior of a recreational trailer according to the present invention.

FIG. 4 is a perspective view showing motorcycle mounts in the recreational trailer according to the present invention.

FIG. 5 is a side view showing the recreational trailer mounted on skids for ice fishing according to the present invention.

Similar reference characters denote corresponding features consistently throughout the attached drawings.

### DETAILED DESCRIPTION OF THE PREFERRED EMBODIMENTS

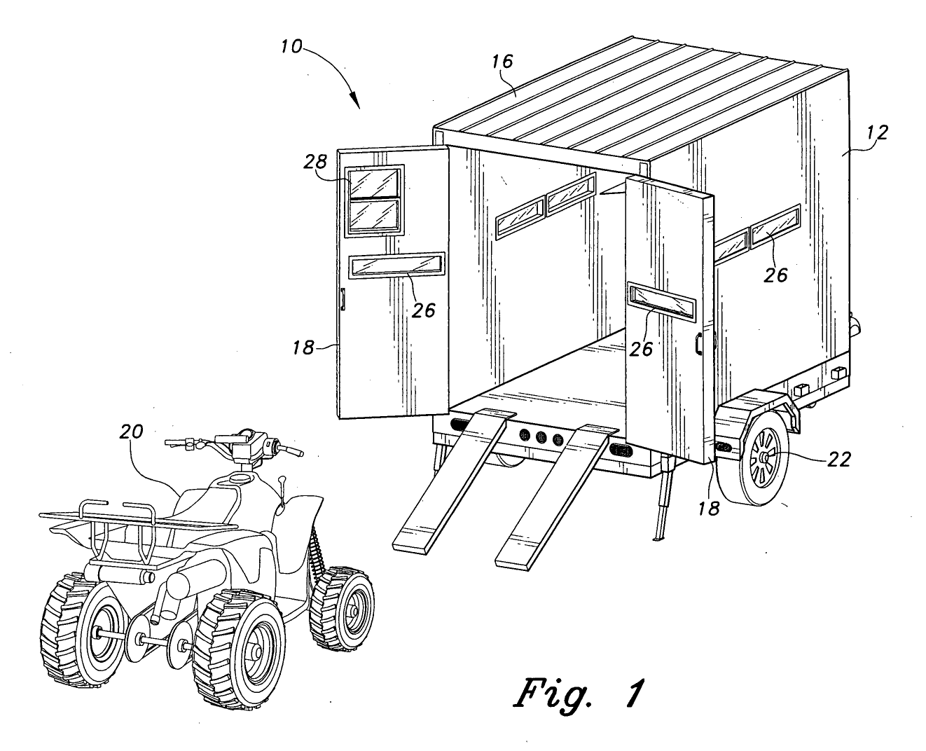

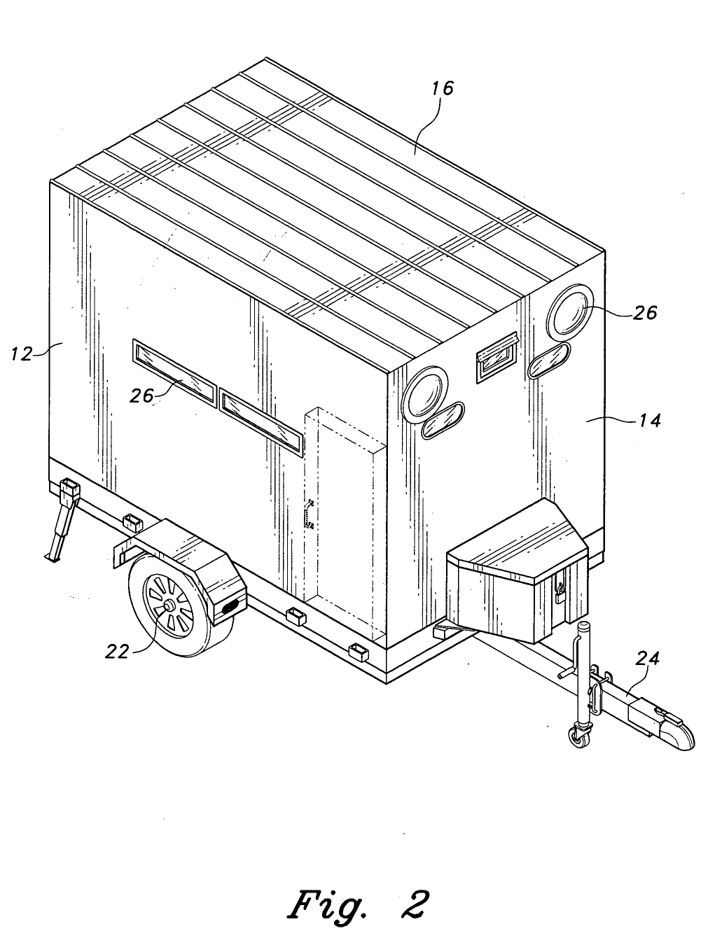

Attention is first directed to FIGS. 1 and 2 wherein the trailer of the instant invention is generally indicated at 10. Trailer 10 has sidewalls 12, front-end wall 14 and a roof 16. Hinged doors 18 define the rear of the trailer. The trailer has a width of approximately 74∴ and a height of approximately 77″. As stated above, the trailer's length may be 6, 10 or 12 feet. The trailer's interior is large enough to house an ATV 20. Trailer 10 is mounted on a wheeled axle 22 and is provided with a hitch-assembly 24 at the front end thereof. Plural windows 26 are disposed in the walls and doors. Air circulation vents 28 are provided at each end of trailer 10. A side door (shown in phantom lines) may be optionally installed if desired.

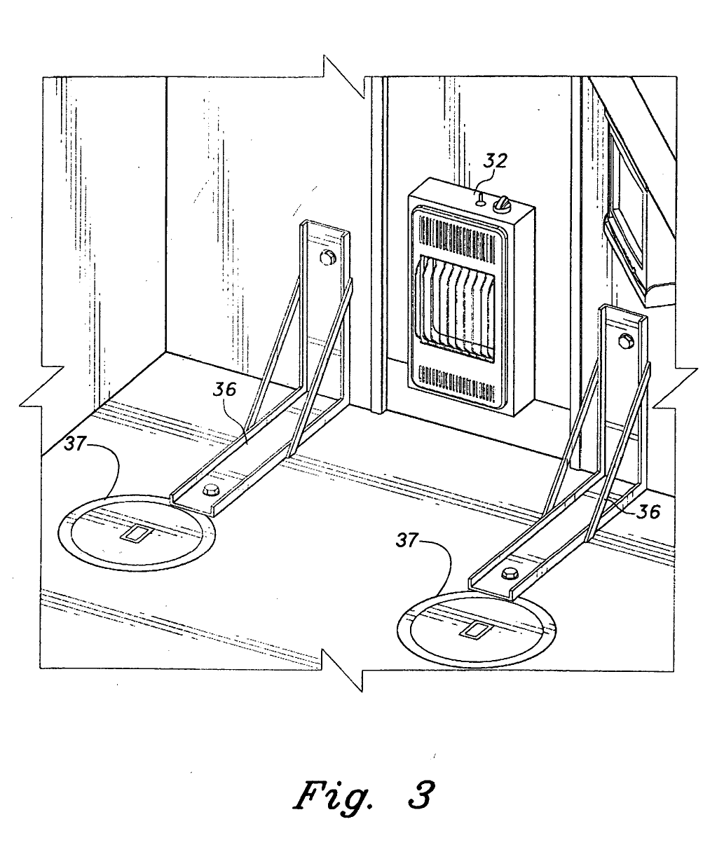

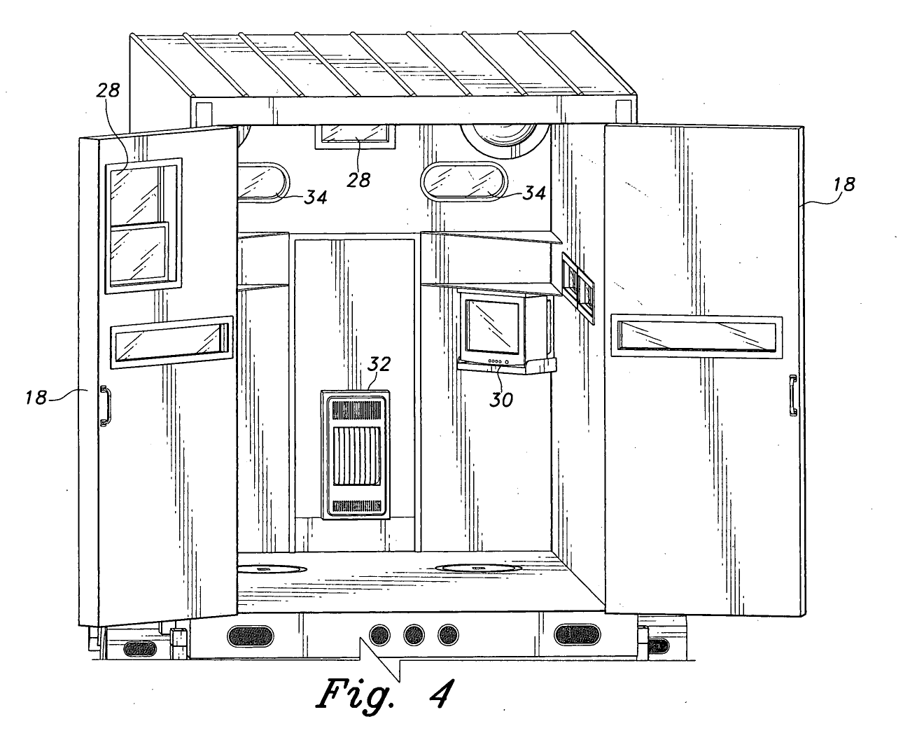

As best seen in FIGS. 3 and 4, the interior of trailer 10 is equipped with amenities such as a TV 30, an electric (or propane) heater 32 and lights 34. Additional amenities may be installed at the owner's option. L-shaped mounts 36 are provided to secure motorcycles in the interior if desired. Covers 37 can be removed to expose openings for ice fishing.

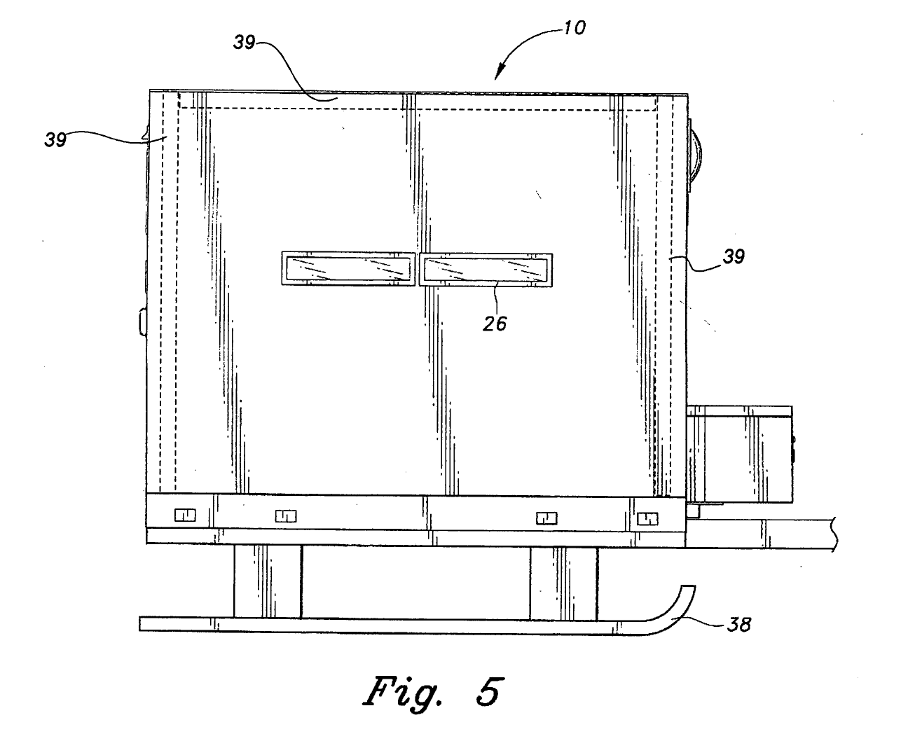

As shown in FIG. 5, trailer 10 can be modified for ice fishing wherein the trailer functions as an ice shanty. Tubular framework is shown in phantom lines at 39. In the instant embodiment trailer 10 is mounted on skis 40 to alleviate frictional drag when the trailer is towed onto the ice. As noted above, an ATV can be employed to tow the lightweight shanty on the ice.

It is to be understood that the present invention is not limited to the embodiments described above, but encompasses any and all embodiments within the scope of the following claims.

1. A lightweight camping and recreational vehicle comprising:
a trailer, said trailer having a first sidewall, a second sidewall, a front end wall, a roof and an open rear end, said first sidewall, second sidewall and end wall enclosing an interior space;
a pair of doors respectively hinged to said first sidewall and said second sidewall at said open rear end, said doors operative to optionally open and close said open rear end;
wherein said first sidewall, said second sidewall, said front end wall and said pair of doors are fabricated from aluminum tubing and sheeting and wherein said roof is fabricated from galvanized steel.

2. A lightweight camping and recreational vehicle as recited in claim 1 wherein said trailer is mounted on a wheeled axle.

3. (canceled)

4. A lightweight camping and recreational vehicle as recited in claim 1, wherein an array of windows is disposed in said first sidewall, said second sidewall, said front end wall and said pair of doors.

5. A lightweight camping and recreational vehicle as recited in claim 1, wherein a TV, an electrical heater and an array of lights are mounted in said interior space.

6. A lightweight camping and recreational vehicle as recited in claim 1, wherein plural, L-shaped motorcycle securing structures are mounted in said interior space.

7. A lightweight camping and recreational vehicle as recited in claim 1, including an air vent disposed in said front end wall.

8. A lightweight camping and recreational vehicle as recited in claim 1, including an air vent disposed in one of said pair of doors.

9. A lightweight camping and recreational vehicle comprising:
a trailer, said trailer having a first sidewall, a second sidewall, a front end wall, a roof and an open rear end, said first sidewall, second sidewall and end wall enclosing an interior space and wherein said trailer has a height of seventy seven inches and a width of seventy four inches;
a pair of doors respectively hinged to said first sidewall and said second sidewall at said open rear end, said doors operative to optionally open and close said open rear end, wherein said first sidewall, said second sidewall, said front end wall and said pair of doors are fabricated from aluminum tubing and sheeting and wherein said roof is fabricated from galvanized steel; and
a wheeled axle, said trailer being mounted on said wheeled axle.

10. A lightweight camping and recreational vehicle as recited in claim 9, wherein an array of windows is disposed in said first sidewall, said second sidewall, said front end wall and said pair of doors.

11. A lightweight camping and recreational vehicle as recited in claim 9, wherein a TV, an electrical heater and an array of lights are mounted in said interior space.

12. A lightweight camping and recreational vehicle as recited in claim 9, wherein plural, L-shaped motorcycle securing structures are mounted in said interior space.

13. A lightweight camping and recreational vehicle as recited in claim 9, including an air vent disposed in said front end wall.

14. A lightweight camping and recreational vehicle as recited in claim 9, including an air vent disposed in one of said pair of doors.

15-20. (canceled)
